(19) United States
(12) Patent Application Publication
(10) Pub. No.: US 2021/0326525 A1
(43) Pub. Date: Oct. 21, 2021

(54) DEVICE AND METHOD FOR CORRECTING CONTEXT SENSITIVE SPELLING ERROR USING MASKED LANGUAGE MODEL

(71) Applicants: Pusan National University Industry-University Cooperation Foundation, Busan (KR); Hancom, Inc., Seongnam-si (KR)

(72) Inventors: Hyukchul KWON, Busan (KR); Jung-Hun LEE, Busan (KR); Minho KIM, Busan (KR)

(73) Assignees: Pusan National University Industry-University Cooperation Foundation, Busan (KR); Hancom, Inc., Seongnam-si (KR)

(21) Appl. No.: 17/218,909

(22) Filed: Mar. 31, 2021

(30) Foreign Application Priority Data
Apr. 16, 2020 (KR) 10-2020-0046011
Nov. 4, 2020 (KR) 10-2020-0146332

(51) Int. Cl. G06F 40/232; G06F 40/279

(52) U.S. Cl. CPC G06F 40/232; G06F 40/279

(57) ABSTRACT

Disclosed is a device for correcting a context sensitive spelling error using a masked language model. The device includes an input unit for inputting a sentence for correction; a correction target word check unit for checking an input sentence in units of a word and searching for a context spelling error; a candidate editing distance selection unit for calculating an editing distance between a word to be corrected and a word dictionary to select a candidate word; a mask candidate generation unit for calculating a distance between an entire context around the word to be corrected and candidate words filtered by the candidate editing distance selection unit; and a correction word presentation unit for selecting a final correction word based on a distance calculation value.

### ACKNOWLEDGEMENT

This work was supported by an Institute of Information & Communications Technology Planning & Evaluation (IITP) grant funded by the Korean government (MSIT) (No. 2020-0-01450, Artificial Intelligence Convergence Research Center [Pusan National University]).

### CROSS-REFERENCE TO PRIOR APPLICATIONS

This application claims priority to Korean Patent Application Nos. 10-2020-0046011 filed on Apr. 16, 2020 and 10-2020-0146332 filed on Nov. 4, 2020, which are all hereby incorporated by reference in their entirety.

### BACKGROUND

The present disclosure relates to spelling error correction, and more particularly, to a device and method for correcting a context sensitive spelling error using a masked language model for enhancing correction accuracy by calculating a distance between selected words and a context by inputting a masked sentence to the masked language model and by presenting a final correction word by ranking the selected words according to the distance.

Recently, artificial intelligence technologies such as deep learning have been actively researched in various fields related to computers around the world.

Various researchers, such as Google Research, Facebook Research, and AllenNLP around the world, are developing deep learning technologies in relation to natural language processing among them, and demand for deep learning-based programs is rapidly increasing in various fields of the industry.

In natural language processing, when correct sentences are input early in an information analysis process, the better results are obtained and thus in natural language processing, context sensitive spelling error correction is important technology that cannot be left out in a preprocessing process.

Spelling errors are largely divided into two types of non-word spelling errors and context sensitive spelling errors.

Non-word spelling errors may be corrected more easily than context sensitive spelling errors, but they come from the school. An error word is determined by comparing whether a word to be corrected is included in the dictionary.

However, in the case of context sensitive spelling errors, the difficulty of correction increases considerably, and for example, in sentences “The letter came from school.” and “The letter came form school.”, “form” becomes an error word, but because “form” and “from” are words existing in a dictionary, it is difficult to solve the error word with a method of correcting a non-word spelling error and thus it should be solved by grasping information on a surrounding context.

In the example, “form”, which is a word in which the alphabet is reversed in “from”, is an error word, but according to the context, “from” may be an error word.

A method of correcting a context sensitive spelling error may be divided into a correction method using rules, a correction method based on statistical information, and a correction method using a neural network.

The rule-based correction method requires experts with advanced linguistics and computer science knowledge when making and verifying rules, and it is practically impossible to make rules that reflect all linguistic phenomena in the real world.

In particular, there is a high probability that a high frequency or a standardized error may be corrected with a rule-based method, but irregular error correction caused by an input error is impossible with only a rule-based method and has much higher correction difficulty.

The statistical correction method may be applied in a language environment where irregular errors often occur and is a method that was mainly suggested before neural network-based correction.

Compared to the speed of development of neural network-based technology, it is difficult to find a case where neural network-based technology is applied to context sensitive spelling error correction technology.

As one of the prior art, there is a method of correcting a context sensitive spelling error using a statistical model based on the frequency of appearances between each vocabulary of a corrected vocabulary pair and a vocabulary appearing in a surrounding context using the preconstructed correction vocabulary pair (Korean Patent Registration No. 10-1495240).

As another method, in a process of generalizing the rule in order to increase the reproducibility of the correction rule, a method of utilizing a Korean vocabulary semantic network has been proposed (Korean Patent Registration No. 10-1500617).

As another method, a method for solving a data shortage problem occurring in a process of calculating the association between each vocabulary of a corrected vocabulary pair and a vocabulary appearing in a surrounding context has been proposed (Korean Patent Registration No. 10-1573854).

As a recently suggested method, a method of correcting context sensitive spelling errors by generating error candidates in real time for various errors has been proposed (Korean Patent Application Laid-open No. 10-2019-0133624).

In such prior art, context sensitive spelling error correction was mainly a statistical method, and a statistical correction method has clear limitations. As a limitation, it is difficult to widely refer to a surrounding context of a word to be corrected, and as a wide range of contexts is referenced, it is difficult to obtain statistical frequency information and a search cost also increases.

In context sensitive spelling error correction, the wider the context is referenced, the more various information may be used for correction, and this was major improvement that was always required in each field of natural language processing.

Therefore, there is a need to develop technology for correcting words by more accurately grasping the association between a word to be corrected and a context.

### PRIOR ART DOCUMENT

### Patent Document

(Patent Document 1) Korean Patent Registration No. 10-1495240
(Patent Document 2) Korean Patent Registration No. 10-1500617
(Patent Document 3) Korean Patent Registration No. 10-1573854
(Patent Document 4) Korean Patent Application Laid-open No. 10-2019-0133624

### SUMMARY

In view of the above, the present disclosure is to solve a problem of spelling error correction technology of the prior art and provides a device and method for correcting a context sensitive spelling error using a masked language model for improving correction accuracy by calculating a distance between selected words and a context by inputting a masked sentence to the masked language model and by presenting a final correction word by ranking the selected words according to the distance.

The present disclosure provides a device and method for correcting a context sensitive spelling error using a masked language model that enables real-time processing by referring to a wider context by correcting context sensitive spelling errors using the masked language model in a process of analyzing a word to be corrected and a surrounding context.

The present disclosure provides a device and method for correcting a context sensitive spelling error using a masked language model that enables correction by more accurately grasping the association between a word to be corrected and a context by correcting context sensitive spelling errors using the masked language model in a process of analyzing the word to be corrected and the surrounding context.

The present disclosure provides a device and method for correcting a context sensitive spelling error using a masked language model applied to context sensitive spelling error correction using pre-train information obtained through in-depth learning and that enables efficient correction based on a language model that has been learned to be robust against spelling errors by learning in a manner of prediction by masking a word of a sentence in a learning process.

The present disclosure provides a device and method for correcting a context sensitive spelling error using a masked language model that enables efficient correction of a context sensitive spelling error that cannot be simply inferred from a dictionary among spelling errors and having the most difficulty in correction.

The present disclosure provides a device and method for correcting a context sensitive spelling error using a masked language model that enables processing of various errors using a distance value between a context and a word to be corrected obtained from a masked language model.

Other objects of the present disclosure are not limited to the above-mentioned objects, and other objects not mentioned will be clearly understood by those skilled in the art from the following description.

In an aspect, a device for correcting a context sensitive spelling error using a masked language model includes an input unit for inputting a sentence for correction; a correction target word check unit for checking an input sentence in units of a word and searching for a context spelling error; a candidate editing distance selection unit for calculating an editing distance between a word to be corrected and a word dictionary to select a candidate word; a mask candidate generation unit for calculating a distance between an entire context around the word to be corrected and candidate words filtered by the candidate editing distance selection unit; and a correction word presentation unit for selecting a final correction word based on a distance calculation value.

The correction target word check unit may include a statistical candidate word set construction unit for searching for a 3-gram dictionary and searching for surrounding context words at a center word position and all appearing statistical candidate words to configure a statistical candidate word set; a context probability calculation unit for calculating a context probability of statistical candidate words of the statistical candidate word set construction unit; and an error word presence/absence determination unit for determining whether there is an error word based on whether an error check target word has a higher or lower context probability than that of the statistical candidate words in the candidate word set.

The candidate editing distance selection unit may calculate a preset editing distance for insertion, deletion, and exchange between words in the entire word dictionary using in the masked language model used for correcting context sensitive spelling errors and a word to be corrected to select a corresponding word from the entire word dictionary.

The mask candidate generation unit may include an editing distance calculation unit for calculating an editing distance with the entire dictionary word of the masked language model based on the word to be corrected; a correction candidate word set construction unit for obtaining a correction candidate word that satisfies an editing distance set with the entire insertion word dictionary of the masked language model based on a central word; and a candidate word distance value calculation unit for replacing the word to be corrected with a mask to calculate a distance value between a context around the mask and the candidate words.

When a word selected by the candidate editing distance selection unit for an input sentence w_{1:n} is C, the mask candidate generation unit may select C in which a context sensitive spelling error correction distance value dis(w₁, w₂, . . . , C, . . . , wₙ₋₁, wₙ) is the maximum, and

$$\hat{C} = {arg max }_{C} dis ( {w}_{1} , {w}_{2} , … , C , … , {w}_{n - 1} , {w}_{n} )$$

may be defined.

In the input sentence, when a word to be corrected is masked, an entire word w_{1:n} of the sentence may be {w₁, w₂, . . . , <mask>, . . . , wₙ₋₁, wₙ} and a set C of words selected by the candidate editing distance selection unit may be replaced by the mask, and a distance value between the context and the selected word may be calculated.

The correction word presentation unit may determine a correction candidate word with a highest value among correction candidate words to a final correction word based on the calculated distance value, and present the word as a substitute.

In another aspect, a method of correcting a context sensitive spelling error using a masked language model includes determining a spelling error correction target word by checking a sentence in units of a word; selecting a word a candidate word through calculation of an editing distance between a word to be corrected and dictionary words in a language model to be a candidate word; calculating a distance between all selected words to replace a masking place and an entire surrounding context using a sentence masked with the word to be corrected in an input sentence; and presenting a final correction word based on ranked information.

The calculating of a distance may include calculating a distance value of the sentence through the masked language model when words selected through calculation of an editing distance and an entire context of a sentence including a word to be corrected are included in the sentence as correction candidates.

The calculating of a distance may include inputting a masked sentence to the masked language model to calculate a distance between the selected words and the context and to rank the selected words according to the distance.

Context sensitive spelling error correction of an entire sentence may include checking errors from a first word to a last word of a sentence, obtaining a set of selected candidate words based on a preset editing distance for a word determined to have errors, calculating a distance value between the entire context and each candidate word to rank the words, and presenting a final correction word, and when the final correction word and the word to be corrected are the same, it may be determined that there is no error, and when the final correction word and the word to be corrected are different, it may be determined that there is an error and the correction word may be replaced.

In the calculating of a distance, a distance value to the context of each candidate word of entire candidate words may be obtained as

$$dis ( {w}_{1} , {w}_{2} , … , C , … , {w}_{n - 1} , {w}_{n} ) = MLM ( masksentence , {candidate}_{1 : N} ) = {candidate distance}_{1 : N}$$

by inputting the masking sentence and the N number of correction candidate words using an MLM function, and candidate distance may be a probability value formed by each candidate extracted from the masked language model and the surrounding context, and a distance may be calculated as a probability using softmax function using when outputting multiple output values up to 1:N as a result, as in an output in the masked language model.

The calculation in the masked language model may be configured in a form of a vector representing all data in deep learning, and all input sentence words masksentence and candidate may be converted into vectors for calculation and then input, and the masked language model may calculate the result for the input sentence in a form of a vector using a parameter that calculates an optimal result learned in advance, and calculate (softmax function) the result as a probability in a final output to output a value in which the sum of the entire result is 1.

As described above, a device and method for correcting a context sensitive spelling error using a masked language model according to the present disclosure have the following effects.

First, in a context sensitive spelling error correction process, a performance of document correction can be significantly improved through grammatical and semantical in-depth analysis by referring to surrounding contexts more widely.

Second, because sentence information is flexibly processed using deep learning technology that processes information in units of a sentence rather than analyzing words and words, it is possible to significantly increase a performance of a context sensitive spelling error correction system.

Third, because the masked language model divides and processes words into sub-units, it is possible to process unregistered words similar in form, so that errors other than the word dictionary can be processed.

Fourth, by correcting the most difficult context sensitive spelling errors in a document correction process, a performance of a document correction device can be significantly improved.

Fifth, because word prediction of a masked portion in an input sentence of the masked language model is made based on the entire word dictionary, difficulty correction of words distant in shape from words to be corrected is also possible, and because the masked language model is used, the performance can also be increased considerably.

### BRIEF DESCRIPTION OF THE DRAWINGS

FIG. 1 is a block diagram illustrating a configuration of a context sensitive spelling error correction device using a masked language model according to the present disclosure.

FIG. 2 is a block diagram illustrating a detailed configuration of a correction target word check unit.

FIG. 3 is a block diagram illustrating a detailed configuration of a mask candidate generation unit.

FIG. 4 is a diagram illustrating a configuration of an example of input/output of a masked language model.

FIG. 5 is a flowchart illustrating a method of correcting a context sensitive spelling error using a masked language model according to the present disclosure.

### DETAILED DESCRIPTION

Hereinafter, a preferred embodiment of a device and method for correcting a context sensitive spelling error using a masked language model according to the present disclosure will be described in detail.

Features and advantages of a device and method for correcting a context sensitive spelling error using a masked language model according to the present disclosure will be apparent through a detailed description of each embodiment hereinafter.

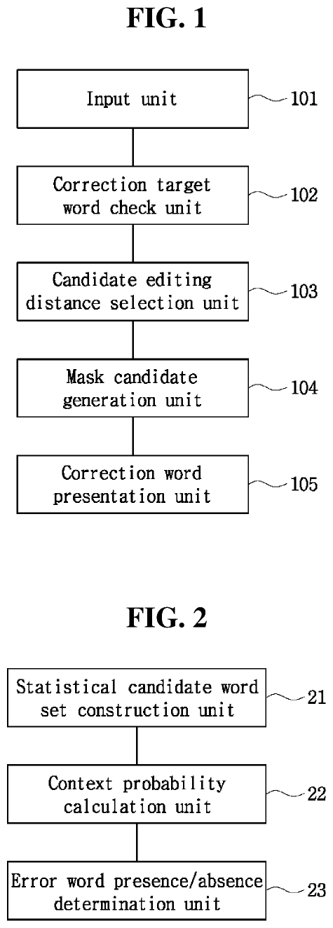

FIG. 1 is a block diagram illustrating a configuration of a context sensitive spelling error correction device using a masked language model according to the present disclosure.

The device and method for correcting a context sensitive spelling error using a masked language model according to the present disclosure includes a configuration for grasping and correcting a relationship between a word to be corrected and an entire context constituting the word to be corrected through a masked language model obtained through in-depth learning.

The masked language model calculates candidate words to come in a mask based on a context of a sentence with a language model learned at every step with a method of predicting the mask by masking a word of the sentence in a learning document.

The present disclosure may include a configuration of calculating a distance between selected words and a context by inputting a masked sentence to a masked language model and presenting a final correction word by ranking the selected words according to the distance to enhance correction accuracy.

The context sensitive spelling error correction device using a masked language model according to the present disclosure includes an input unit 101 for inputting a sentence for correcting an error, a correction target word check unit 102 for sequentially checking words of a sentence input through the input unit 101 and checking whether there is an error in the word, a candidate editing distance selection unit 103 for selecting candidate words for a word to be corrected when it is determined that there is an error in the word, a mask candidate generation unit 104 for replacing the word to be corrected with a mask to calculate a distance value between a surrounding context of the mask and the candidate words, and a correction word presentation unit 105 for finally presenting a candidate word close to the context, as illustrated in FIG. 1.

A detailed configuration of the correction target word check unit 102 is as follows.

FIG. 2 is a block diagram illustrating a detailed configuration of a correction target word check unit.

The correction target word check unit 102 includes a statistical candidate word set construction unit 21 for searching for a 3-gram dictionary and searching for surrounding context words at a center word position and all appearing statistical candidate words to configure a statistical candidate word set, a context probability calculation unit 22 for calculating a context probability of the statistical candidate words of the statistical candidate word set construction unit 21, and an error word presence/absence determination unit 23 for determining whether there is an error word based on only that an error check target word has a higher or lower context probability than that of the statistical candidate words in the candidate word set.

A detailed configuration of the mask candidate generation unit 104 is as follows.

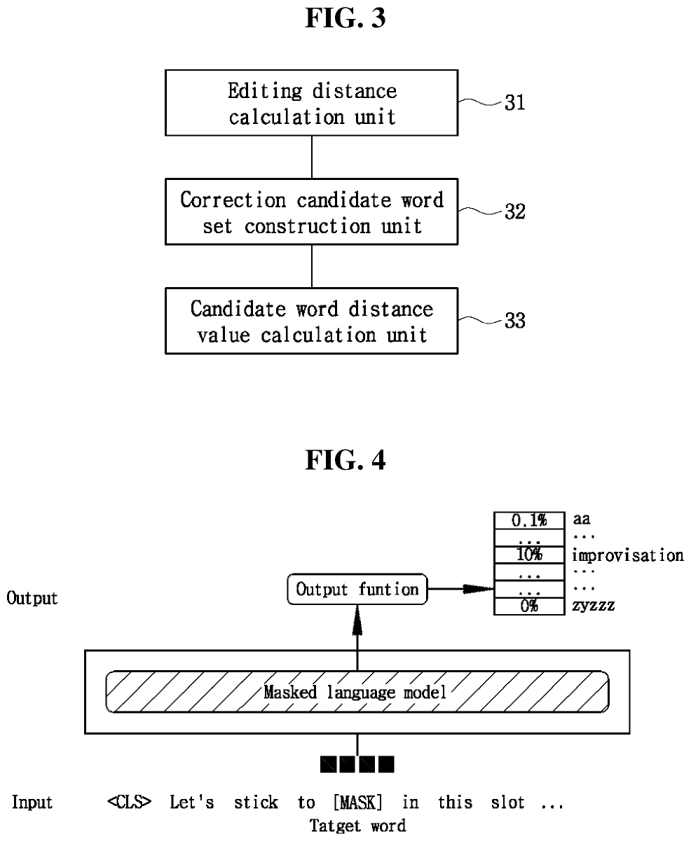

FIG. 3 is a block diagram illustrating a detailed configuration of a mask candidate generation unit.

The mask candidate generation unit 104 includes an editing distance calculation unit 31 for calculating an editing distance with the entire dictionary words of the masked language model based on the word to be corrected, a correction candidate word set construction unit 32 for obtaining a correction candidate word satisfying an entire insertion word dictionary of the masked language model and a preset editing distance based on a central word, and a candidate word distance value calculation unit 33 for replacing the word to be corrected with a mask to calculate a distance value between a surrounding context of the mask and candidate words.

Each step of the method of correcting a context sensitive spelling error using a masked language model according to the present disclosure will be described in detail as follows.

The correction target word check unit 102 and the mask candidate generation unit 104 use each different language model, and the language model refers to a model using for natural language or understanding.

The correction target word check unit 102 is an N-gram model, which is a statistical language model, and Equation 1 calculates a context probability of p(wₜ|wₜ₋₂,wₜ₋₁)p(wₜ₊₁|wₜ₋₁,wₜ)p(wₜ₊₂|wₜ,wₜ₊₁)p(Y|W) to be the maximum among statistical candidate words for surrounding contexts wₜ₋₂, wₜ₋₁, wₜ₊₁, and wₜ₊₂ of a position wₜ of the word to be corrected where the set T of statistical candidate words is replaced.

A statistical language model to be used only in a step of checking the word to be corrected determines whether there is an error word according to only whether a probability of the word to be corrected is higher or lower compared to that of the statistical candidate words in the set T of candidate words.

Statistical candidate words are different from correction candidate words and are used only in a process of checking the word to be corrected.

$$\hat{T} = {argmax }_{{w}_{t} ∈ f ( T )} p ( {w}_{t} \vert {w}_{t - 2} , {w}_{t - 1} ) p ( {w}_{t + 1} \vert {w}_{t - 1} , {w}_{t} ) p ( {w}_{t + 2} \vert {w}_{t} , {w}_{t + 1} ) p ( Y \vert W ) \qquad [ Equation 1 ]$$

Statistical candidate words are obtained through a preconstructed 3-gram dictionary, and are obtained by searching for 3-grams in a range of two words at both sides based on a central word position ‘*’, and context words around the central word position and all appearing statistical candidate words are searched for.

The found words belong to the candidate word set, and a word of a current correction target check words and an editing distance are calculated to select nearby words.

The editing distance starts from 1, and becomes a reference for comparing the difference between words. As the alphabet or phoneme of a comparison word is inserted, deleted, or exchanged from a reference word, the editing distance increases.

For example, in a reference word ‘result’ and a comparison word ‘resul’, ‘resul’ in which the alphabet ‘t’ has been deleted from the reference word has an editing distance of 1 from ‘result’.

candidate words=<w₋₂,w₋₁,*>∪<w₋₁,*,w₁>∪<*,w₁,w₂> [Equation 2]

The mask candidate generation unit 104 uses a masked language model, and as illustrated in FIG. 2 illustrating a configuration of an input/output example of the masked language model, the masked language model is a model that replaces ‘<mask>’ at a position of a word to be predicted in the input sentence to predict the corresponding word through the masked language model.

The masked language model is the result of in-depth learning obtained in advance through prior learning, and is obtained by masking some words of a learning sentence with ‘<mask>’ and by repeating learning.

In Equation 3, in a sentence w_{1:n} input to the masked language model and a set C of correction candidate words selected by the selection unit, Ĉ in which a context sensitive spelling error correction distance value dis (w₁, w₂, . . . , C, . . . , wₙ₋₁, wₙ) is the maximum is selected.

$$\hat{C} = {arg max}_{C} dis ( {w}_{1} , {w}_{2} , … , C , … , {w}_{n - 1} , {w}_{n} ) \qquad [ Equation 3 ]$$

C representing the set of correction candidate words of Equation 3 is the N number of set obtained as correction candidate words satisfying the entire insertion word dictionary of the masked language model and the preset editing distance based on the center word wₜ using an editing distance calculation function EDF, as in Equation 4.

C=EDF(wₜ,embedding voca_{1:V})=candidate_{1:N},(V≥N) [Equation 4]

A dis function in Equation 3 calculates a distance value of the correction candidate word C and the entire context w₁, w₂, . . . , C, . . . , wₙ₋₁, wₙ, and obtains a distance value with the context of each candidate word by inputting the masking sentence and the N number of correction candidate words using an MLM function, as in Equation 5.

$$dis ( {w}_{1} , {w}_{2} , … , C , … , {w}_{n - 1} , {w}_{n} ) = MLM ( masksentence , {candidate}_{1 : N} ) = {candidate distance}_{1 : N} \qquad [ Equation 5 ]$$

In Equation 5, candidate distance is a probability value formed by each candidate extracted from the masked language model and the surrounding context, and a distance is calculated as a probability using a softmax function using when outputting multiple output values up to 1:N as a result, as in the output in the masked language model.

The calculation in the masked language model is configured in a form of a vector representing all data in deep learning, and all input sentence words masksentence and candidate are converted into vectors for calculation and then input.

The masked language model calculates the result of an input sentence in the form of a vector using a parameter that calculates an optimal result learned in advance, and calculates (softmax function) the result as a probability in a final output, and gives a value in which the sum of the entire result is 1.

The masked language model is entirely applied to an autoencoding-based language model that checks a bidirectional context, and an internal operation method of the resulting vector has structural diversity according to the language model.

The method of correcting a context sensitive spelling error using a masked language model according to the present disclosure will be described in detail as follows.

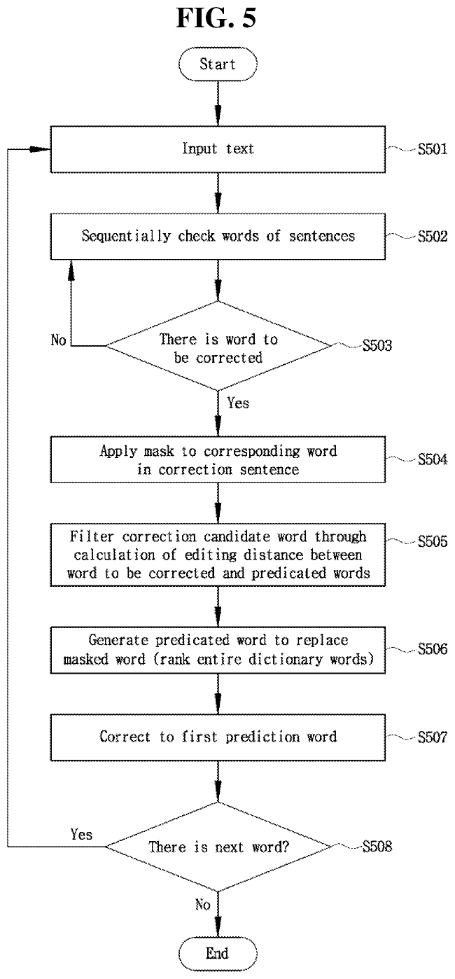

FIG. 5 is a flowchart illustrating a method of correcting a context sensitive spelling error using a masked language model according to the present disclosure.

First, a context sensitive spelling error is searched for and a document to be corrected is input (S501), words of sentences in the document are sequentially checked (S502), and it is determined whether there is an error in the word (S503).

When there is no error in the word, the next word is checked, and when it is determined that there is an error in the word, the word is determined as a word to be corrected, and a mask is applied to the word to be corrected (S504).

In order to reduce an amount of calculation before calculating a distance to the context using the correction candidate words, an editing distance with the entire dictionary words of the masked language model is calculated based on the word to be corrected to determine candidate words for a preset distance (S505), a distance value between the surrounding context of the mask and each candidate word is obtained using the masked language model based on the determined candidate word (S506), and a first highest rank word is selected as a final correction word (S507).

Here, when the correction word is the same as the word to be corrected, the correction has not been made, and when the correction word is different from the word to be corrected, the correction is performed by replacing the correction word.

After a process of predicting the word to be corrected is finished, it is determined whether there is a next word or sentence (S508), and it is determined whether to terminate the system.

In the present disclosure, a method of correcting a context sensitive spelling error using the masked language model sequentially checks whether words from a first word to a last word are words to be corrected based on units of a sentence.

As an example of a check of a word to be corrected, when there is a sentence ‘ . . . county should receive some portion of these available . . . ’, it is assumed that ‘county’, ‘should’, ‘receive’, ‘some’, ‘portion’, ‘of’, ‘these’, ‘available’, . . . are each word and that a central word that is currently being checked for correction is ‘some’.

In a preconstructed large 3-gram dictionary based on the central word ‘some’, (‘should’, ‘receive’, ‘*’), (‘receive’, ‘*’, ‘portion’), (‘*’, ‘portion’, ‘of’) in a range of 2 words are searched for, ‘sane’, ‘save’, ‘name’, ‘same’, ‘dome’, ‘sole’, ‘rome’, ‘home’, etc., which are a set of candidate words in a context that may be disposed at a position of ‘*’ are obtained, and ‘same’, ‘dome’, ‘sole’, etc., which are a set of candidate words having a close editing distance with the central word ‘some’ are obtained.

For reference, when it is calculated not only a simple editing distance but also a distance from a keyboard to the alphabet where the central word has been changed, a better effect can be obtained.

Next, the probability of a context in a range of two words is calculated based on the central word, and here, when the probability of the sentence of the context ‘should receive some portion of’ in the range of two words including the central word ‘some’ and the probability when ‘some’ is replaced by each candidate word in the context in the range of two words are compared with a calibration value, if the probability of the context including ‘some’ is the highest, it is determined that there is no error in the word, and among the candidate words, when there is a candidate word in which the probability with the context is higher than the probability of ‘some’, it is determined that there is an error.

When it is determined that the word is a word to be corrected, a sentence . . . , ‘county’, ‘should’, ‘receive’, ‘<mask>’, ‘portion’, ‘of’, ‘these’, ‘available’, . . . in which the central word ‘some’ is replaced with ‘<mask>’, is first inserted into the masked language model.

The masked language model is a language model that has been learned in advance through in-depth learning, and as illustrated in FIG. 2, by inputting the entire masked context, at the output, words to come in ‘<mask>’ are predicted based on the entire context except for the central word, and a distance to the context is calculated for the entire embedding vocabulary dictionary of words used in a learning process.

In order to reduce an amount to be calculated through the masked language model, words such as ‘same’, ‘dome’, and ‘sole’ having an editing distance close to ‘some’ are selected from the entire insertion word dictionary, a distance value with a surrounding context of ‘<mask>’ is calculated in the masked language model among these correction candidate words, and these correction candidate words are ranked.

When a first rank candidate word is the same as a word ‘some’ to be corrected, it is determined that there is no error in the word, and when there are other candidate words, it is determined that there is an error in the word and the word is corrected.

This process is sequentially repeated until the input document is finished, and the final correction result is output.

The above-described device and method for correcting a context sensitive spelling error using a masked language model according to the present disclosure can process various errors using a distance value between a context and words to be corrected obtained from a masked language model in a spelling error correction step and calculates a distance between the selected words and the context by inputting a masked sentence to the masked language model, and presents a final correction word by ranking the selected words according to the distance to enhance correction accuracy.

As described above, it will be understood that the present disclosure is implemented in a modified form without departing from essential characteristics of the present disclosure. Therefore, the specified embodiments should be considered from a descriptive point of view rather than a limiting point of view, and the scope of the present disclosure is illustrated in the claims rather than the above description, and it will have to be interpreted that all differences within the scope equivalent thereto are included in the present disclosure.

### DETAILED DESCRIPTION OF MAIN ELEMENTS

101: input unit
102: correction target word check unit
103: candidate editing distance selection unit
104: mask candidate generation unit
105: correction word presentation unit

What is claimed is:

1. A device for correcting a context sensitive spelling error using a masked language model, the device comprising:
an input unit for inputting a sentence for correction;
a correction target word check unit for checking an input sentence in units of a word and searching for a context spelling error;
a candidate editing distance selection unit for calculating an editing distance between a word to be corrected and a word dictionary to select a candidate word;
a mask candidate generation unit for calculating a distance between an entire context around the word to be corrected and candidate words filtered by the candidate editing distance selection unit; and
a correction word presentation unit for selecting a final correction word based on a distance calculation value.

2. The device of claim 1, wherein the correction target word check unit comprises:
a statistical candidate word set construction unit for searching for a 3-gram dictionary and searching for surrounding context words at a center word position and all appearing statistical candidate words to configure a statistical candidate word set;
a context probability calculation unit for calculating a context probability of statistical candidate words of the statistical candidate word set construction unit; and
an error word presence/absence determination unit for determining whether there is an error word based on whether an error check target word has a higher or lower context probability than that of the statistical candidate words in the candidate word set.

3. The device of claim 1, wherein the candidate editing distance selection unit calculates a preset editing distance for insertion, deletion, and exchange between words in the entire word dictionary using in the masked language model used for correcting context sensitive spelling errors and a word to be corrected to select the corresponding word from the entire word dictionary.

4. The device of claim 1, wherein the mask candidate generation unit comprises:
an editing distance calculation unit for calculating an editing distance with the entire dictionary word of the masked language model based on the word to be corrected;
a correction candidate word set construction unit for obtaining a correction candidate word that satisfies an editing distance set with the entire insertion word dictionary of the masked language model based on a central word; and
a candidate word distance value calculation unit for replacing the word to be corrected with a mask to calculate a distance value between a context around the mask and the candidate words.

5. The device of claim 1, wherein, when a word selected by the candidate editing distance selection unit for an input sentence w_{1:n} is C, the mask candidate generation unit selects C in which a context sensitive spelling error correction distance value dis(w₁, w₂, . . . , C, . . . , wₙ₋₁, wₙ) is the maximum, and
$$\hat{C} = {arg max}_{C} dis ( {w}_{1} , {w}_{2} , … , C , … , {w}_{n - 1} , {w}_{n} )$$
is defined.

6. The device of claim 5, wherein in the input sentence, when a word wₜ to be corrected is masked, an entire word w_{1:n} of the sentence is {w₁, w₂, . . . , <mask>, . . . , wₙ₋₁, wₙ} and a set C of words selected by the candidate editing distance selection unit is replaced by the mask, and a distance value between the context and the selected word is calculated.

7. The device of claim 1, wherein the correction word presentation unit determines a correction candidate word with a highest value among correction candidate words to a final correction word based on the calculated distance value, and presents the word as a substitute.

8. A method of correcting a context sensitive spelling error using a masked language model, the method comprising:
determining a spelling error correction target word by checking a sentence in units of a word;
selecting a word through calculation of an editing distance between a word to be corrected and dictionary words in a language model to be a candidate word;
calculating a distance between all selected words to replace a masking place and an entire surrounding context using a sentence masked with the word to be corrected in an input sentence; and
presenting a final correction word based on ranked information.

9. The method of claim 8, wherein the calculating of a distance comprises calculating a distance value of the sentence through the masked language model when words selected through calculation of an editing distance with an entire context of a sentence including a word to be corrected are included in the sentence as correction candidates.

10. The method of claim 8, wherein the calculating of a distance comprises inputting a masked sentence to the masked language model to calculate a distance between the selected words and the context and to rank the selected words according to the distance.

11. The method of claim 8, wherein context sensitive spelling error correction of an entire sentence comprises checking errors from a first word to a last word of a sentence, obtaining a set of selected candidate words based on a preset editing distance for a word determined to have errors, calculating a distance value between the entire context and each candidate word to rank the words, and presenting a final correction word, and
when the final correction word and the word to be corrected are the same, it is determined that there is no error, and when the final correction word and the word to be corrected are different, it is determined that there is an error and the correction word is replaced.

12. The method of claim 8, wherein in the calculating of a distance, a distance value to the context of each candidate word of entire candidate words is obtained as
$$dis ( {w}_{1} , {w}_{2} , … , C , … , {w}_{n - 1} , {w}_{n} ) = MLM ( masksentence , {candidate}_{1 : N} ) = {candidate distance}_{1 : N}$$
by inputting the masking sentence and the N number of correction candidate words using an MLM function, and
candidate distance is a probability value formed by each candidate extracted from the masked language model and the surrounding context, and a distance is calculated as a probability using a softmax function using when outputting multiple output values up to 1:N as a result, as in an output in the masked language model.

13. The method of claim 12, wherein the calculation in the masked language model is configured in a form of a vector representing all data in deep learning, and all input sentence words masksentence and candidate are converted into vectors for calculation and then input, and
the masked language model calculates the result for the input sentence in a form of a vector using a parameter that calculates an optimal result learned in advance, and calculates (softmax function) the result as a probability in a final output to output a value in which the sum of the entire result is 1.
